(19) United States
(12) Patent Application Publication
(10) Pub. No.: US 2007/0102245 A1
(43) Pub. Date: May 10, 2007

(54) Elevator device

(76) Inventors: Shusaku Shibasaki, Saitama-ken (JP); Makoto Yoshihara, Chiba-ken (JP); Yasuhiro Goto, Chiba-ken (JP); Senzo Alberto Naruke, Chiba-ken (JP)

Correspondence Address: Lisa A Bongiovi;Otis Elevator company, Intellectual Property Dept, Ten Farm Springs, Farmington, CT, 06032, US

(21) Appl. No.: 10/557,519

(22) PCT Filed:
(86) PCT No.: PCT/IB04/02329

(30) Foreign Application Priority Data
May 27, 2003 (JP) 2003-148719

(51) Int. Cl. B66B 7/02

(52) U.S. Cl. 187/406

(57) ABSTRACT

An elevator car (8) is guided vertically by diagonally arranged guide rails (3A, 3B).

### TECHNICAL FIELD OF THE INVENTION

The present invention pertains to an elevator for transporting passengers and cargo. In particular, the present invention pertains to the guidance of the elevator cab.

### PRIOR ART

FIG. 7 is a plan view illustrating a conventional underslung traction elevator. The elevator car moves in shaft (1) formed by shaft walls (2). Opening (2a) is formed in shaft wall (2) as an exit/entrance to a given floor at a height corresponding to each floor. A pair of first guide rails (3a), (3b), arranged and fixed vertically, surround car (8), which moves within shaft (1), on either side, and the vertical movement of car (8) is guided by said pair of first guide rails (3a), (3b). On the other hand, on the side of car (8), counterweight (5) is arranged to move freely vertically via a pair of second guide rails (4a), (4b).

The upper portion of first guide rail (3b) is coupled to support member (6) that extends horizontally. On one end side, first joining unit (15) is set for joining one end of three drive ropes (7). The other ends of said drive ropes (7) pass through a pair of pulleys (9a), (9b) mounted on the lower side of car (8), are wound on drive sheave (10a) of hoist machine (10) set on a connecting platform between the upper portions of second guide rails (4a), (4b), and are then joined to the lower side of said connecting platform via pulley (11) installed on counterweight (5). Similarly, upper sheave (19) of a car overspeed governor is set at the other end of support member (6).

With regard to this type of elevator, efforts have been made to reduce the space occupied by hoist (10) in the shaft by making it smaller and thinner. When a metal cable with an approximately circular cross section is used as the drive rope, in order to meet the safety code, the outside diameter of the drive sheave must be at least more than 40 times the approximate outside diameter of the drive rope. Efforts to reduce the diameter of the drive sheave, that is, reduce the size of hoist (10), are thereby limited, and it is impossible to reduce the area of the sheave past a certain limit. This is also true for the outside diameter of the pulleys attached to car (8) and counterweight (5), and the dimension of the shaft in the vertical direction is affected.

As a method to solve this problem, a flat rope having a flat cross section prepared by embedding a core material made of metal or synthetic fibers in a synthetic resin, is used as the drive rope. As a result, it is possible to reduce the diameter of the drive sheave, the size of the hoist machine, the outside diameter of the pulleys attached to car (8) and counterweight (5), and the area and dimensions in the vertical direction of the shaft.

However, to further reduce the area of the shaft, in addition to reducing the size of hoist (10), it is also necessary to improve the configuration of the equipment in the shaft.

For example, because first guide rails (3a), (3b) are placed in the prior art at symmetrical positions with respect to car (8), first guide rail (3a) is arranged between counterweight (5) and car (8), and the width of shaft (1) is increased corresponding to thickness G of first guide rail (3a).

### SUMMARY OF THE INVENTION

According to the present invention, the pair of first guide rails for guiding the car between them is not arranged symmetrically with respect to the car. Instead, the guide rails are arranged at approximately diagonal positions with the car disposed between them, with one of said first guide rails not arranged between the car and the counterweight.

In the elevator according to the present invention, since one of said first guide rails is not arranged between the car and the counterweight, the width of the shaft can be reduced corresponding to the thickness of the first guide rail. Also, since one of said pair of first guide rails is arranged near a pair of second guide rails having the counterweight arranged between them, it is possible to share fixtures for fixing said guide rails in the shaft. As a result, it is possible to reduce the number of members and the manufacturing cost. Also, by joining these members, it is possible to increase the strength of the guide rails.

According to a further embodiment of the present invention, a support member is arranged in a cantilevered configuration near the upper end of said first guide rail on the side opposite said hoist machine with respect to the car between said pair of first guide rails set at approximately diagonal positions with said car disposed between them; said support member supports one end of said drive rope and the upper sheave of a car overspeed governor.

Since the support member is supported in cantilevered fashion near the upper end portion of the first guide rail and the first guide rails are arranged at approximately diagonal positions with said car arranged between them, it is possible to support one end of the drive rope and the upper sheave of the governor, with load borne by the first guide rails.

According to a further embodiment of the present invention, the hoist machine is arranged between the inner wall of said shaft and the space traversed by the movement of said car, including the space extending vertically therefrom.

According to a still further embodiment of the present invention, a deflector wheel is arranged on said drive rope between said hoist and said car and/or between said hoist and said counterweight, thereby avoiding the risk of interference between the drive rope and other structural members installed near the hoist.

Also according to a further embodiment of the present invention, the car frame provided for said car has an approximately rectangular parallelepiped shape.

The car frame according to the present invention can stably support the car with respect to a deviated load due to cargo carried in the car or the like when the first guide rails are set at approximately diagonal positions.

According to a final embodiment of the present invention, said drive rope is a flat rope with a flat cross section, thereby allowing a reduction in the outer diameters of the drive sheave, deflector wheels, and pulleys, and, since the outside diameters of the drive sheave, etc., are reduced, the hoist and brake can be made correspondingly smaller. As a result, the dimensions of the shaft can be reduced.

These and other advantages and features of the present invention will be apparent to those skilled in the art upon review of the following description and the appended claims and drawing figures.

### BRIEF DESCRIPTION OF THE DRAWINGS

FIG. 1 illustrates a first of the elevator of the present invention. FIG. 1A is a plan view; FIG. 1B is a front view.

FIG. 2 is an oblique view illustrating an enlarged view of a portion of FIG. 1.

FIG. 3 illustrates a second embodiment of the elevator of the present invention. FIG. 3A is a plan view; FIG. 3B is a partial front view.

FIGS. 4A and 4B illustrate alternate arrangements of FIG. 3.

FIG. 5 is an oblique view illustrating the car frame of the elevator of the present invention.

FIG. 6 is a plan view illustrating an embodiment of the elevator of the present invention.

FIG. 7 is a plan view illustrating a conventional elevator as known in the prior art.

### DETAILED DESCRIPTION

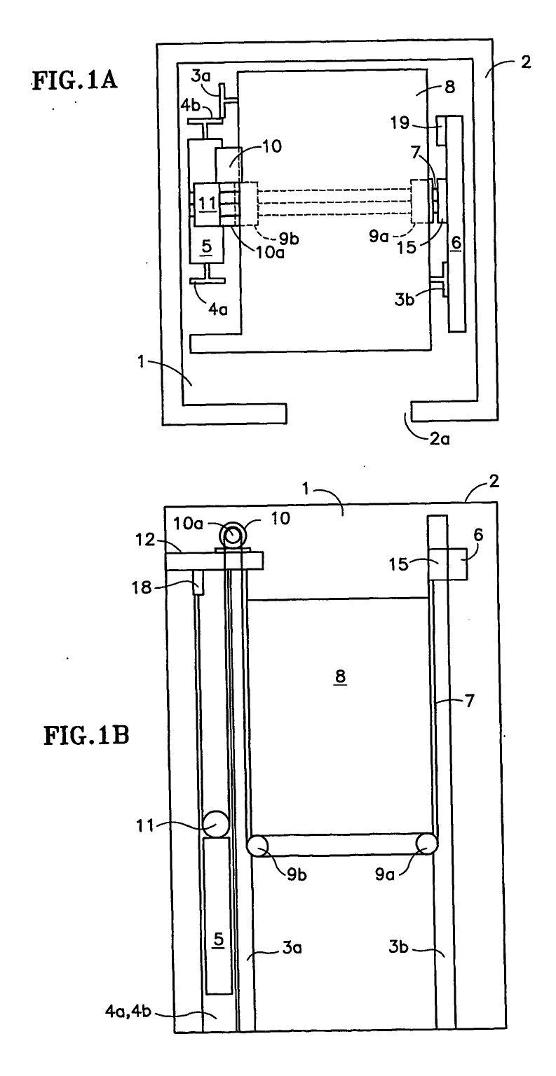

Referring now to FIG. 1, shaft wall (2) that forms shaft (1) for lifting the car is set inside a building, and opening portion (2a) is formed as an exit/entrance to the car on shaft wall (2) at the height corresponding to each floor. Inside shaft (1), a pair of first guide rails (3a), (3b) is set and fixed in the vertical direction with car (8) arranged between them for lifting movement. Said pair of first guide rails (3a), (3b) has nearly T-shaped cross sections. Said first guide rails (3a), (3b) are fitted in a freely sliding way in the corresponding slots of slotted guide shoes (not shown in the figure) and installed on the upper side and lower side of said car (8).

As shown in FIG. 1, said pair of first guide rails (3a), (3b) are not set in a left/right symmetrical configuration with respect to car (8). Instead, they are placed at approximately diagonal positions with car (8) arranged between them. Consequently, first guide rail (3a) need not be set between car (8) and counterweight (5). As a result, the width of the shaft can be reduced corresponding to the thickness of first guide rail (3a) for a given car size.

Additionally, on the side of car (8), counterweight (5) is arranged so that it can rise freely via a pair of second guide rails (4a), (4b). Said second guide rails (4a), (4b) also have approximately T-shaped cross sections. Said second guide rails (4a), (4b) are fitted in a freely sliding way in the slots of slotted guide shoes (not shown in the figure) and installed on the upper side and lower side of counterweight (5). Connecting platform (12) is arranged near the upper end portion of said pair of second guide rails (4a), (4b) with means for connecting and supporting said second guide rails (4a), (4b). Hoist machine (10) is also supported on connecting platform (12).

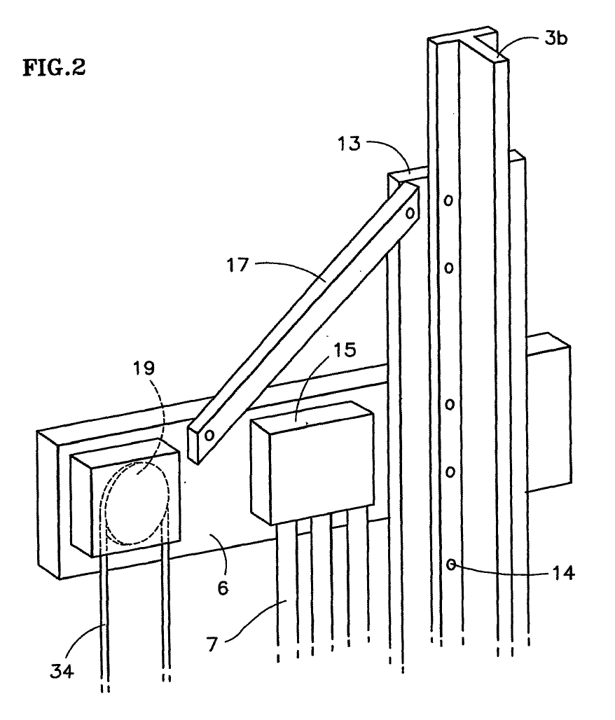

One end of each of the three drive ropes (7) is fastened to support member (6) that extends in the horizontal direction on the upper portion of first guide rail (3b). FIG. 2 illustrates the structure of this area. Reinforcing plate (13) is joined to first guide rail (3b) by means of plural bolts (14), and support member (6) is joined via reinforcing plate (13) on the upper portion of first guide rail (3b). Support member (6) has a cantilevered structure. First joining portion (15) for holding one end of each of the three drive ropes (7) and upper sheave (19) of a governor for operating an emergency stopping device when the car falls at an abnormal speed are set on support member (6). Because support member (6) has a cantilevered structure, for reinforcement, the two ends of brace member (17) are joined to reinforcing plate (13) and support member (6).

Because one end of each drive rope (7) is fastened through first joining portion (15) to support member (6) joined to first guide rail (3b), a bending load is applied on first guide rail (3b). However, since first guide rail (3b) and support member (6) are joined by means of brace member (17), the generation of bending deformation of first guide rail (3b) is reduced.

As shown in FIG. 1(b), said drive rope (7) is wound on drive sheave (10a) of hoist machine (10) on connecting platform (12) through a pair of pulleys (9a), (9b) mounted on the lower side of car (8). The other end of drive rope (7) is wound on pulley (11) arranged on the upper portion of counterweight (5), and it is then fastened to the lower side of said connecting platform (12) through second joining portion (18).

According to the present invention, a flat rope having a flat cross section is used as drive rope (7). By means of said flat rope, it is possible to reduce the outside diameters of drive sheave (10a) and pulley (11). Since the outside diameters of drive sheave (10a), etc. are reduced, it is possible to reduce the size of hoist (10) and the brake (not shown in the figure). As a result, it is possible to reduce the dimensions of shaft (1). The flat rope has a flat cross section and is prepared by embedding a core material made of metal or synthetic fibers in a synthetic resin. It is lightweight, has long service life, and low extensibility. In addition, since the contact area between the flat rope and the drive sheave is large, the friction between them is high, so that there is no need to form slots on drive sheave (10a) to increase the friction. Also, since there are no grooves, the load applied to the drive rope and drive sheave is reduced, and there is less wear than on a drive rope of the prior art made of metal with an approximately circular cross section. Also, since the flat rope is lightweight, it is possible to reduce the adjusted load of the weight balance between the car and the counterweight in consideration of the weight of the drive rope when the lifting path becomes larger.

Also, one of said pair of first guide rails (3a), (3b) is arranged near one of said pair of second guide rails (4a), (4b) with counterweight (5) arranged between the rails. Consequently, it is possible to share the joining members for fixing said guide rails in shaft (1), so that it is possible to reduce the number of the joining members and the manufacturing cost. Also, by joining and integrating these guide rails, it is possible to increase their strength.

By means of combining a constitution in which a pair of first guide rails (3a), (3b) are arranged at approximately diagonal positions with car (8) arranged between them, and a constitution in which a flat rope with a flat cross section is used as drive rope (7), it is possible to reduce the dimensions of shaft (1) in 2 stages, so that the dimensions of shaft (1) can be further reduced.

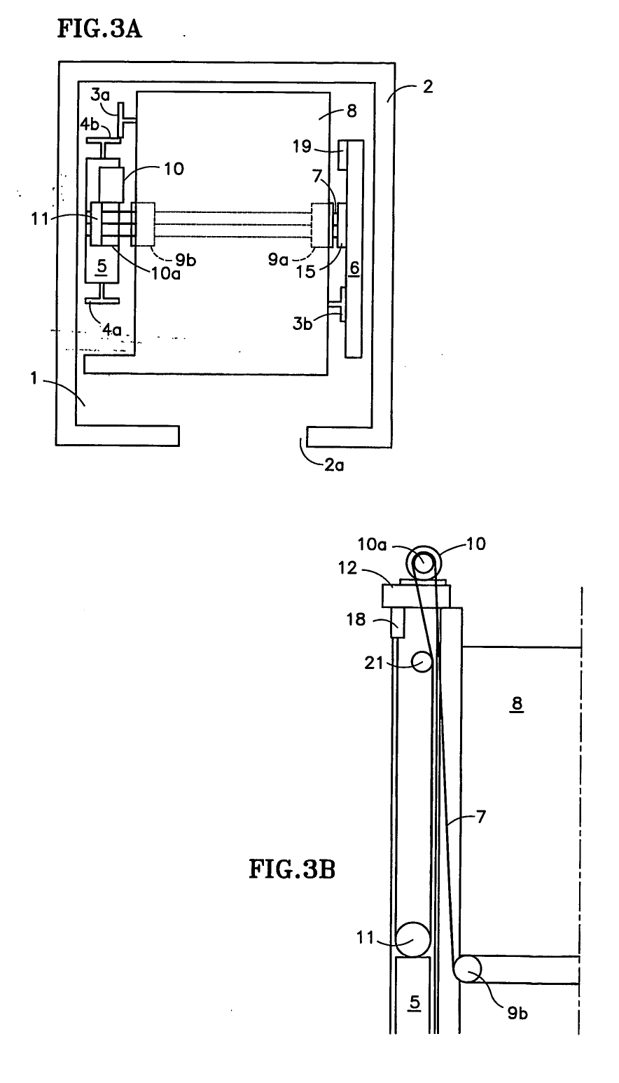

Referring now to FIG. 3, second embodiment of the present invention will be described. In this embodiment, as can be seen by comparing FIGS. 3(b) and 1(b), connecting platform (12) with hoist (10) is arranged in the space between the shaft wall and the space for lifting movement of car (8). This elevator differs from that shown in FIG. 1 in that hoist machine (10) is absent in the space traversed by the lifting movement of car (8) and the space of its extended region. The height at which hoist (10) is set is such that when car (8) is positioned on the uppermost floor, said hoist is lower than the ceiling of car (8). As a result, it is possible to reduce the overhead dimensions, that is, the height from the floor surface of the uppermost floor of the building to the top of the shaft. Also, maintenance personnel on top of the car can more easily service the hoist machine (10).

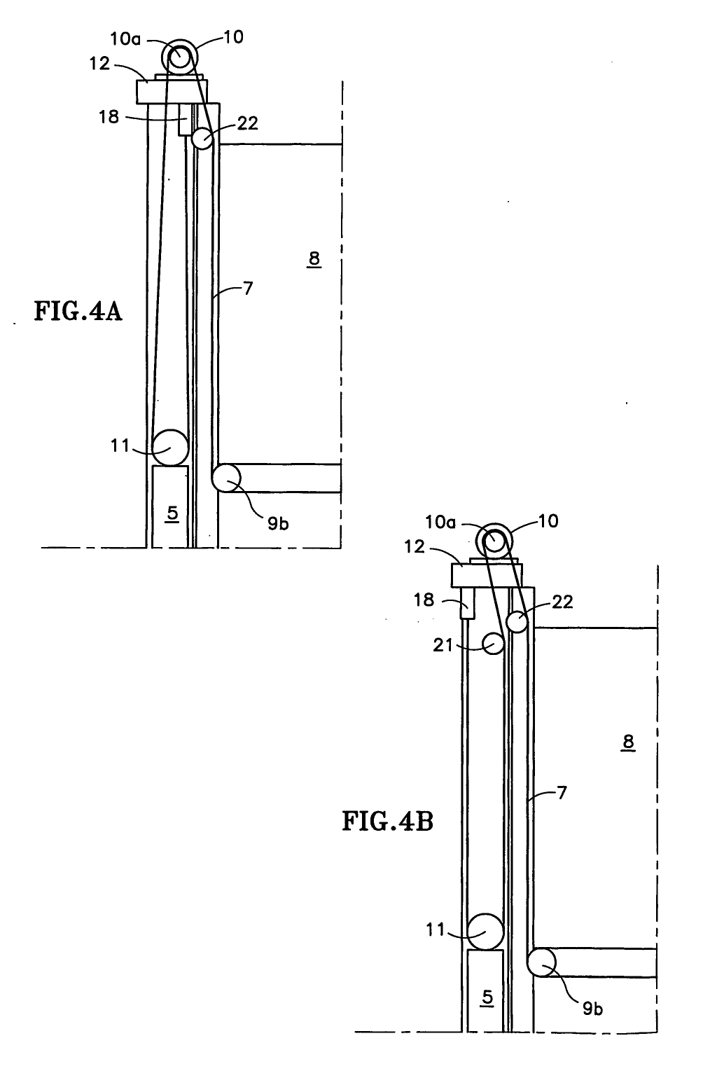

In addition, as shown in FIG. 3(b), deflector wheel (21) is arranged on drive rope (7) between hoist machine (10) and counterweight (5). As a result, there is no danger of interference between drive rope (7) with other structural members set near the hoist machine (10). Also, as another structural example, deflector wheel (22) may be set on drive rope (7) between the hoist machine (10) and car (8) as shown in FIG. 4(a), or deflector wheels (21), (22) may be arranged between hoist machine (10) and counterweight (5) and between hoist machine (10) and car (8), respectively, as shown in FIG. 4(b).

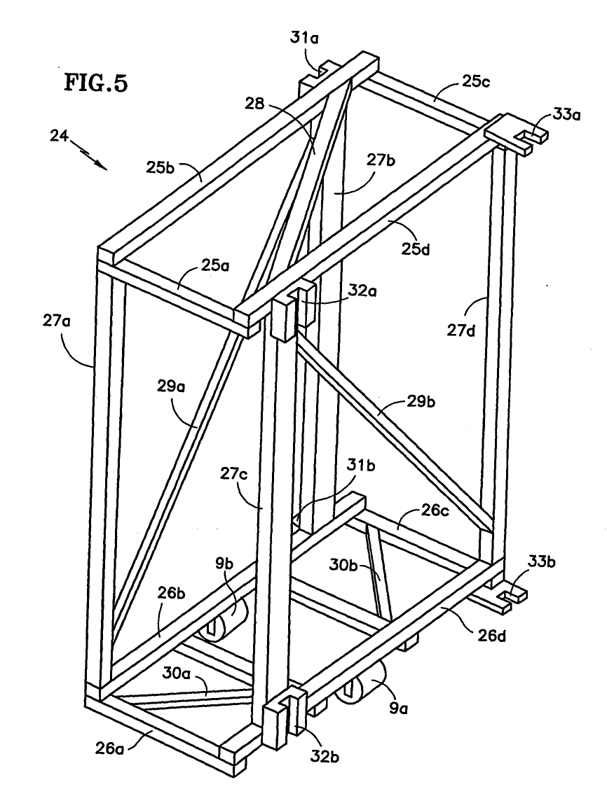

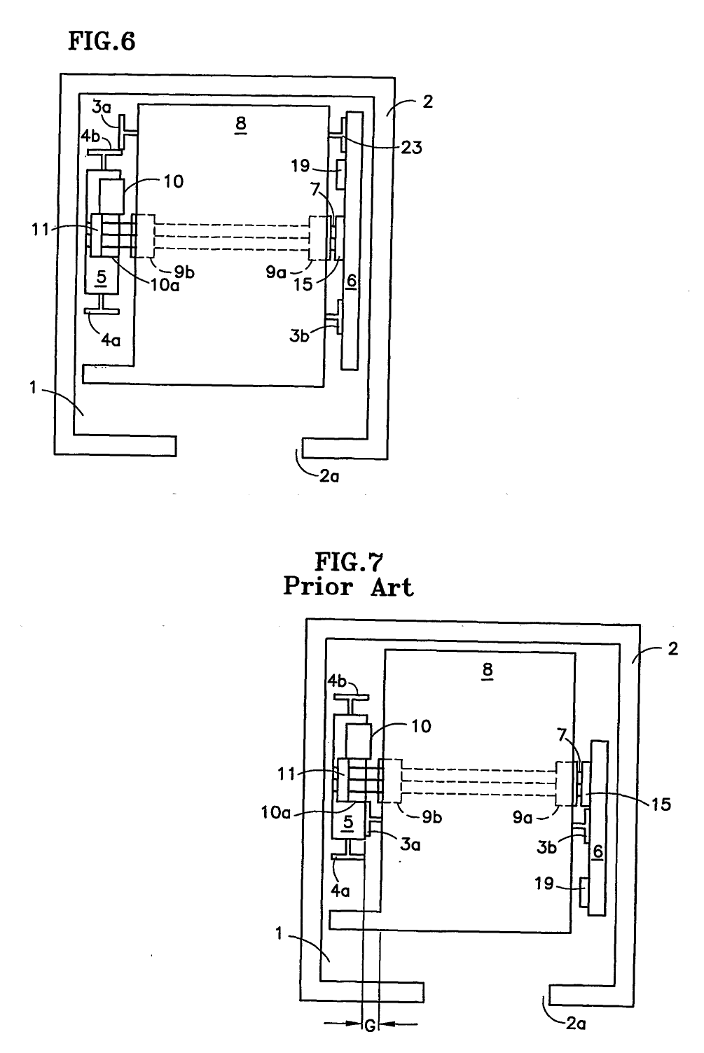

FIG. 5 is a diagram illustrating car frame (24) of car (8) according to the present invention. Car frame (24) is composed of four upper frames (25a)-(25d) and four lower frames (26a)-(26d), and four vertical frames (27a)-(27d), and it has an approximately rectangular parallelepiped shape. Also, for reinforcement, brace member (28) is set in the diagonal direction of the upper frame portion, brace members (29a), (29b) are set in the diagonal direction of the vertical frame portion, and brace members (30a), (30b) are set in the lower frame portion. Guide shoes (31a), (31b) and guide shoes (32a), (32b) are installed on the upper and lower sides in the approximately diagonal positions of car frame (24), and are fitted to first guide rails (3a), (3b) to slide freely. Also, guide members (33a), (33b) with slots for fitting of the third guide rail (23) for preventing derailment are installed on the upper and lower sides of car frame (24). (9a), (9b) are pulleys installed on the left and right sides of the lower portion of car frame (24).

An elevator car body (not shown in the figure) is contained inside car frame (24) with the aforementioned constitution to form car (8). As a result, even when first guide rails (3a), (3b) are set at approximately diagonal positions with car (8) arranged therebetween, it is possible to keep car (8) dimensionally stable against deviated load due to shifting cargo in car (8), etc.

Also, the number of drive ropes is not limited to three. Four or more drive ropes may be used in correspondence to the length of the lifting path and the load of the car.

As explained above, in the elevator of the present invention, by combining a constitution which has a pair of first guide rails arranged at approximately diagonal positions with the car arranged between them and a constitution using a flat rope with a flat cross section as the drive rope, it is possible to reduce the dimensions of the shaft in two stages, that is, it is possible to further reduce the dimensions of the shaft.

1-7. (canceled)

8. An elevator comprising:
a car is guided in a shaft to move vertically along a pair of first guide rails between which the car is arranged;
a counterweight is guided to move vertically via a pair of second guide rails between which the counterweight is arranged;
a drive rope that connects the car and the counterweight is wound on the drive sheave of a hoist so that as the drive sheave is driven to rotate, the car and the counterweight move vertically in opposite directions,
wherein the first guide rails are arranged at approximately diagonal positions with the car therebetween.

9. The elevator of claim 8, wherein a support member is arranged in cantilevered configuration near the upper end of the first guide rail on the side opposite the hoist with respect to the car between the pair of first guide rails arranged at approximately diagonal positions with the car arranged between them, the support member supports one end of the drive rope and the upper sheave of a car overspeed governor.

10. The elevator of claim 8, wherein the hoist is arranged between an inner wall of the shaft and a space for the vertical movement of the car as well as a space extending therefrom.

11. The elevator of claim 8, wherein a deflector wheel is arranged on the drive rope between the hoist and the car and/or between the hoist and the counterweight.

12. The elevator of claim 8, wherein a car frame that contains the car has an approximately rectangular parallelepiped form.

13. The elevator of claim 8, wherein a third guide rail is arranged as a derailment prevention means for preventing the car from derailing from the pair of first guide rails.

14. The elevator of claim 8, wherein the drive rope is flat with a rectangular cross section.
